(19) United States
(12) Patent Application Publication
(10) Pub. No.: US 2002/0050782 A1
(43) Pub. Date: May 2, 2002

(54) Display panel

(75) Inventors: Atsushi Ito, Tokyo (JP); Hironobu Arimoto, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 09/814,723

(22) Filed: Mar. 23, 2001

(30) Foreign Application Priority Data
Nov. 1, 2000 (JP) 2000-334705

(51) Int. Cl. H01J 1/62; H01J 63/04; H01J 17/49

(52) U.S. Cl. 313/495; 313/583; 313/582

(57) ABSTRACT

The invention provides a display panel in which a problem of chipping at the end portion of the display panel is greatly reduced. The invention also provides a display panel in which the end portion of the display panel is prevented from incidence and reflection of light, thereby improving uniformity of brightness of a system screen. The display panel comprises a display panel body 2 including a first glass 3 and a second glass 4, the first glass 3 having a plurality of display cells 6 provided with a gas discharging space on a surface thereof, and the second glass 4 being disposed on the first glass 4 to be opposite to the display cells 6, and a protective film 7 covering not only a display surface 21 and side face 22 of the display panel body 2 but also at least a part of the back side thereof. It is possible to form a colored portion serving as a color filter and a black matrix for light shielding in the protective film 7.

### BACKGROUND OF THE INVENTION

1. Technical Field

The present invention relates to a display panel and, more particularly, to a display panel for implementing a display by driving a plurality of display cells arranged into a matrix using gas discharge.

2. Background Art

The inventors have previously proposed a display panel in an international patent application under the Patent Cooperation Treaty (Application number PCT/JP98/01444). The display panel disclosed in the PCT application comprises a first glass having a plurality of display cells arranged into a matrix on the surface of the glass, and a second glass opposite to the mentioned plurality of display cells. In the display panel, each display cell is driven by gas discharge and includes a common electrode and a cell electrode for the driving. The cell electrode is driven for each display cell, while the common electrode is driven collectively for the plurality of cells. In this process, positive display pulses are applied to the common electrode, and application of positive control voltage by the cell electrode is separately performed, whereby the discharge is controlled for each display cell. To form a display panel, a large screen display system is constructed by arranging longitudinally and transversely a plurality of unit panels each being of 8 cm square. As each unit panel is small in seal width, it is possible to form a substantially joint-widthless large screen display.

Since two sheets of thin glass plates as described above form the mentioned display panel, it is necessary to handle with a great care not to break the glass plates during or after manufacturing thereof. Hence a problem exists in that manufacturing efficiency is rather low. Moreover, in the process of forming such a large screen, each display panel is arranged close to each other in order to leave the joint-width as small as possible. Accordingly, a distance between the display panels becomes extremely small. Hence, another problem exists in that a fracture or chipping is apt to occur at the end portion of the display panel during arranging. To cope with this, it is possible to apply an end treatment for the glass such as chamfering. In such means of solution, however, there is a disadvantage that the edge treatment of the glass, itself, is not enough to prevent the fracture or chipping, and brings about increase in cost. There is a further disadvantage that the edge treated portion of the glass may impede a part of light emitted from the cells located end portion of the display panel.

Generally, in the mentioned conventional display panel, a color filter is employed for the purpose of improving contrast and color purity. As method for applying this color filter, several attempt have been proposed including printing a color filter on the interior or exterior portion of the display panel, adhering a film-like color filter onto the surface of the display panel. The mentioned method of adhering a color filter was disclosed in the Japanese Patent Publication (unexamined) No. 2019/1988, etc. However, during the process of printing or adhering the color filter, fracture or chipping may occur at the mentioned end portion.

As described above, the mentioned display panel is used in the form of a matrix typed is play system comprising a plurality of display panels longitudinally and transversely arranged. In actual use, any light emitted from the display cells located at the most exterior side of each display panel may reflect on the end face of the glass, and any light may come incident from outside through the end portion of the display panel. As a result, a further problem exists in that a light reflected from a fluorescent substance of the display cell is visually recognized white. Caused by the mentioned problem, a disadvantage occurs in that, when looking the matrix type screen system as a whole, the portion between one display panel and another looks white eventually resulting in uneven brightness of the system screen.

### SUMMARY OF THE INVENTION

The present invention was made to solve the above-discussed problems and has an object of providing a display panel in which the problem of chipping at the end portion of the display panel is greatly reduced. Another object of the invention is to provide a display panel in which the end portion of the display panel is prevented from incidence and reflection of light, thereby improving uniformity of brightness of a system screen.

To accomplish the foregoing object, (1) a display panel according to the present invention comprises: a display panel body including a first glass and a second glass, said first glass having a plurality of display cells provided with a gas discharging space on a surface thereof, and said second glass being disposed on the mentioned first glass to be opposite to the mentioned display cells; and a protective film covering not only a display surface and sides of the mentioned display panel body but also at least a part of the back side thereof.

(2) In the foregoing construction (1), it is preferable that the protective film is adhered to the display panel body.

In this manner, the protective film is adhered extending to the back side of the display panel body without exposing the end portion of the display panel body. Therefore, external force, etc. that may be given to the mentioned end portion can be dispersed by the protective film, and the end portion can be prevented from fracture and chipping. As a result, it becomes possible to handle the display panel of the invention with ease, and to assemble efficiently, for example, a large size display system using the display panel of the invention.

(3) In the foregoing construction (1), it is preferable that the protective film is provided with a color portion serving as a color filter at a portion covering the display surface of the display panel body.

As a result, the protective film performs also a function of color filter.

(4) In the foregoing construction (1) or (3), it is preferable that the protective film is provided with a black matrix for light shielding at the portion covering the display surface of the display panel body.

As a result, color contrast between pixels is improved.

(5) In the foregoing construction (1), it is preferable that the protective film is colored at a portion covering the sides of the display panel body.

By this coloring, the display panel can be prevented from light shielding and reflection of light. Therefore, it becomes possible to prevent the reflection, on the end face of the glass plate, of the light emitted from the display cells located in the most exterior side of each display panel as well as the incidence of external light through the end portion of the display panel. As a result, in the matrix type display system formed by a plurality of the display panels according to the invention, the problem that the portion between one display panel and another looks white is solved, and uniformity in brightness is improved.

(6) In the foregoing construction (1) or (3), it is preferable that the protective film is provided with an ultraviolet ray-cutting layer and/or a mat-treated layer thereon. As a result, the ultraviolet ray-cutting layer acts to prevent the coloring material applied to the protective film for forming R, G, B regions of the color filters from discoloration due to chemical deterioration or degradation. At the same time, the mat-treated layer is able to disperse external light. Particularly, any light reflected from the display surface of the display panel body in a certain direction including reflection of a fluorescent light in the room, sunbeam, etc. is dispersed, thus influence of such light being reduced.

(7) In the foregoing construction (1) or (2), it is preferable that the display panel is provided with a pressing member for pressing a portion of the protective film covering the back surface of the display panel body onto the mentioned back side.

(8) In the foregoing construction (7), it is preferable that the pressing member is a box-like member accommodating therein a driving member that drives the display panel body. Generally, adhesive strength of the portion of the protective film covering the backside of the display panel body is not so strong that the protective film may separate from the display panel body. But, pressing the part of the protective film covering the backside of the display panel body with the pressing member can prevent such separation.

(9) In the foregoing construction (1), it is preferable that the display panel body is in the form of a flat plate. As a result, it becomes possible to assemble a large size flat display system.

### BRIEF DESCRIPTION OF THE DRAWINGS

FIG. 1 is a partially cross-sectional side view showing a display panel according to Embodiment 1 of the present invention.

FIG. 2 is a partially enlarged sectional view taken along the line II-II shown in FIG. 1.

FIG. 3 is a top plan view of a developed protective film according to Embodiment 1.

FIG. 4 is an explanatory view to explain a manufacturing method of the protective film according to Embodiment 1.

FIG. 5 (a) is a perspective view of a display unit assembled with the display panels according to Embodiment 1, and FIG. 5 (b) is an exploded perspective view of a display system using the display unit.

FIG. 6 is a diagram showing a drive circuit of the display system according to Embodiment 1.

FIG. 7 is a partially cross-sectional side view showing a display panel according to Embodiment 2 of the invention.

FIG. 8 is a top plan view of a developed protective film according to Embodiment 2.

FIG. 9 is a partially enlarged sectional view of a display panel according to Embodiment 3 of the invention.

FIG. 10 is a partially enlarged sectional view of a display panel according to Embodiment 4 of the invention.

FIG. 11 is a side view partially in cross-section of a display panel according to Embodiment 5 of the invention.

### DESCRIPTION OF THE PREFERRED EMBODIMENTS

Several preferred embodiments are hereinafter described with reference to the accompanying drawings, in which same reference numerals are designated to like parts throughout the same. Description of such like parts is omitted in Embodiment 2 and after, just referring to the description of those in Embodiment 1.

### Embodiment 1

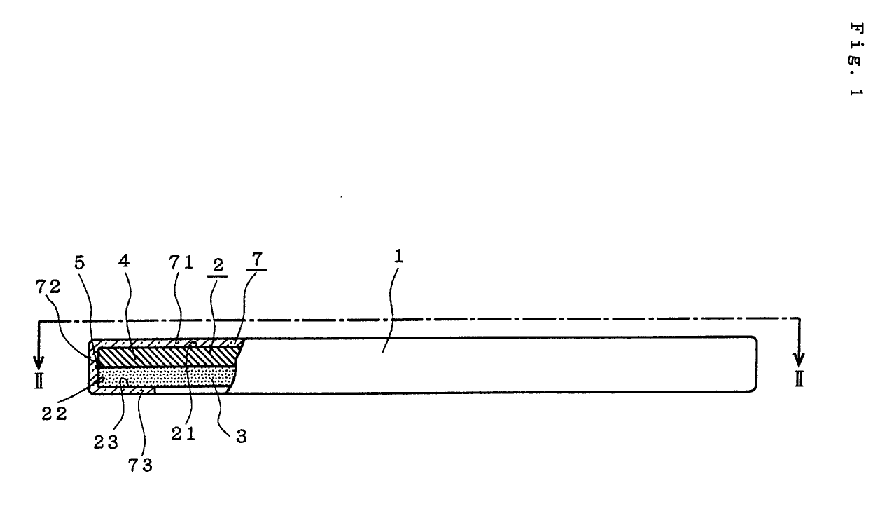

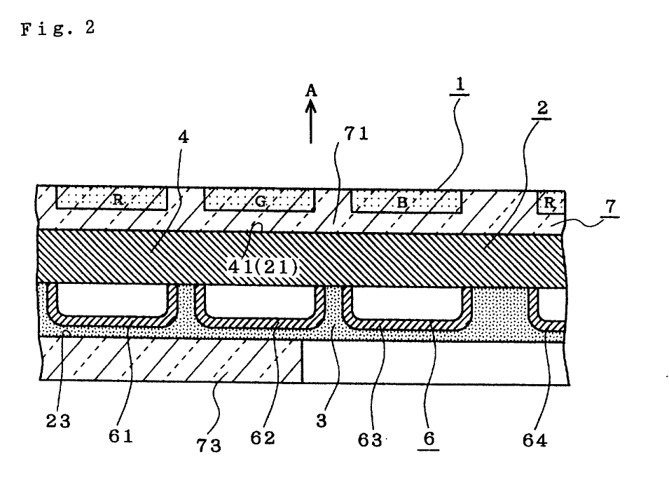

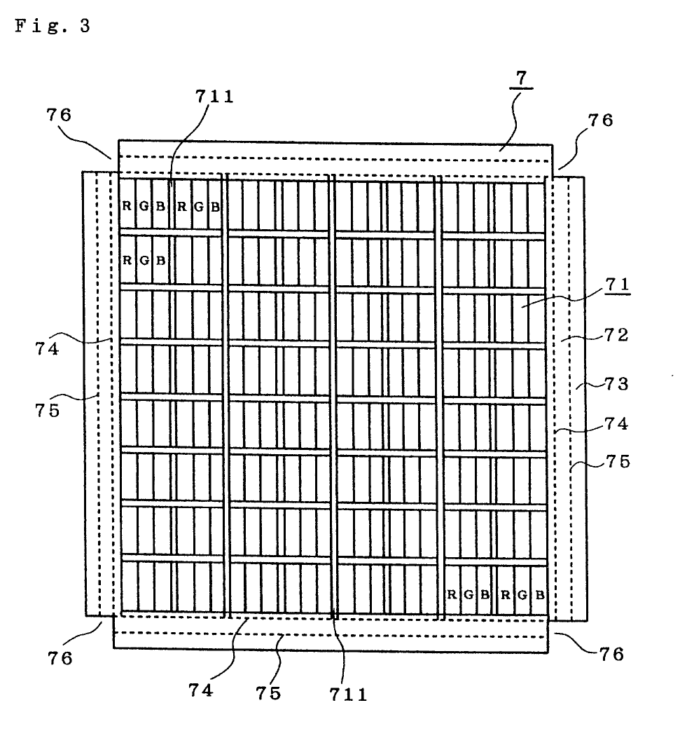

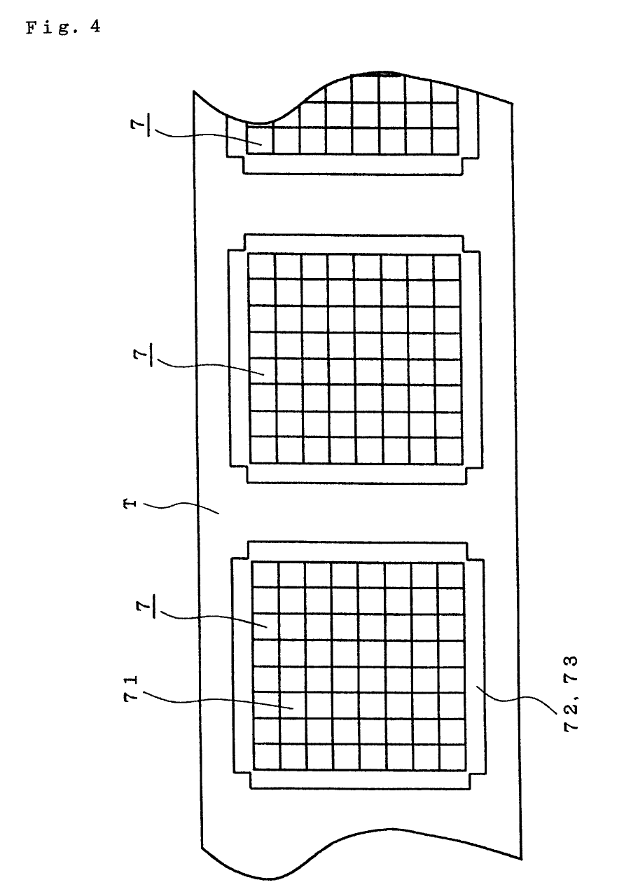

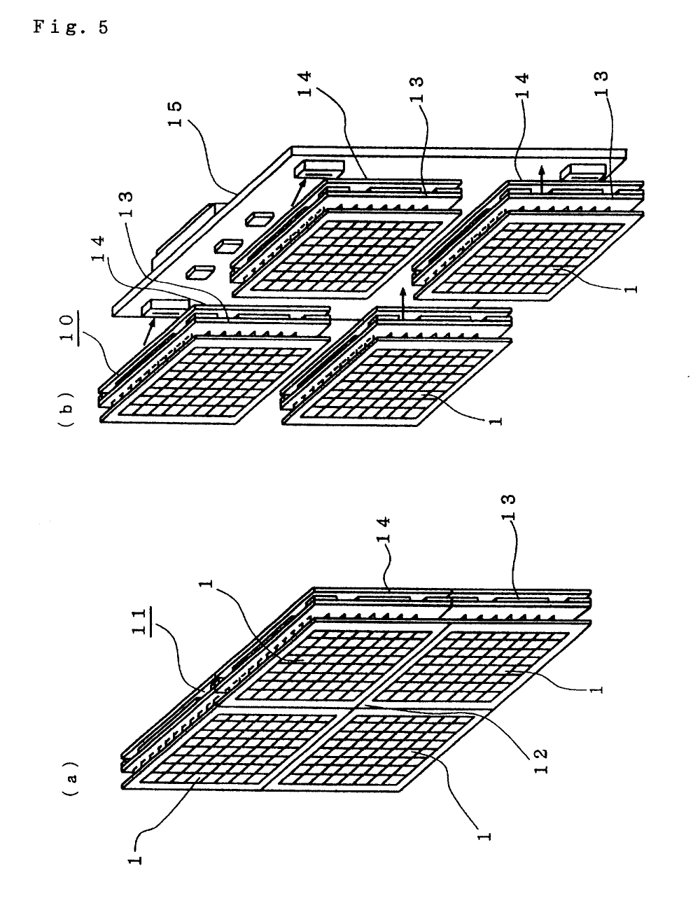

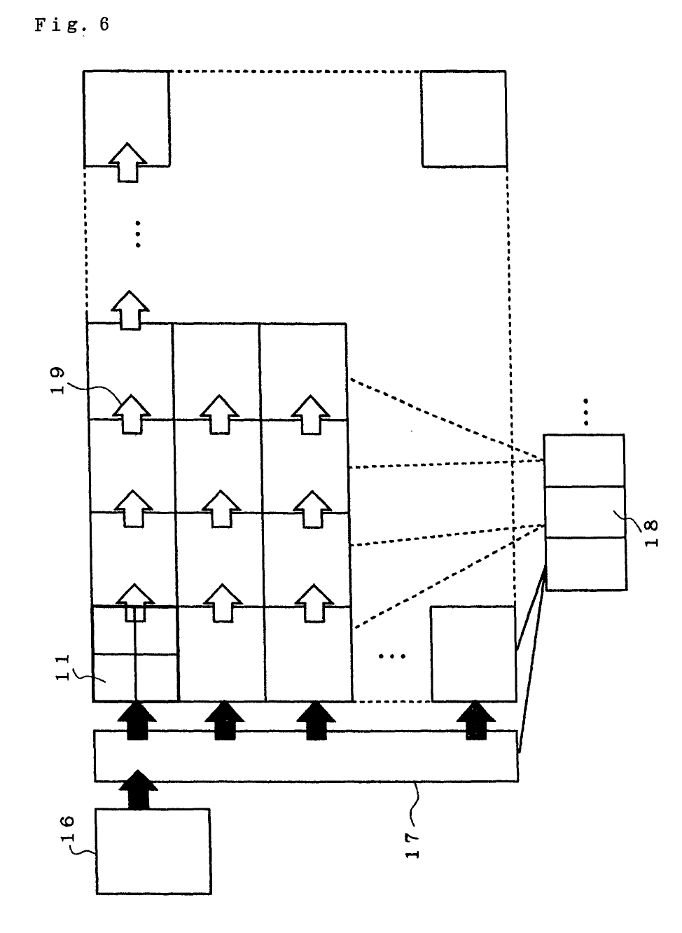

FIGS. 1 to 6 show Embodiment 1 of a display panel according to the present invention, and in which FIG. 1 is a partially cross-sectional side view showing a display panel FIG. 2 is a partially enlarged sectional view taken along the line II-II shown in FIG. 1, FIG. 3 is a top plan view of a developed protective film, and FIG. 4 is an explanatory view to explain a manufacturing method of the protective film. FIG. 5 (a) is a perspective view of a display unit assembled with the display panels, FIG. 5 (b) is an exploded perspective view of a display system using the display unit, and FIG. 6 is a diagram showing a drive circuit of the display system.

In FIGS. 1 to 6, reference numeral 1 is a display panel, numeral 2 is a display panel body, numeral 3 is a first glass sometimes referred to as back glass, and numeral 4 is a second glass sometimes referred to as a front glass. Numeral 5 is a seal glass sealing the first glass 3 and the second glass 4, numeral 6 is a display cell, and numeral 7 is a protective film. The display panel 1 is comprised of the display panel body 2 and the protective film 7, and the display panel body 2 is comprised of the first glass 3, the second glass 4 and the display cell 6. The second glass 4 is disposed on the first glass 3 and opposite to the display cell 6. Both glasses 3, 4 are flat monolithic sheet glass and mutually sealed to be airtight with the seal glass 5 on the peripheral edge.

The display cell 6 is comprised of a plurality of display cell parts 61, 62, 63, etc., and the display cell parts 61, 62, 63, etc. are respectively disposed in a plurality of dents formed into a matrix arrangement on the surface of the first glass 3. Accordingly, the plural display cell parts are disposed forming a matrix. Each display cell part is cup-shaped in cross section. Internal part of each cup-shaped display cell part is painted with a fluorescent material, and inside space thereof is charged with a gas for gas discharging, e.g., xenon. Further, the display cell part 61 shown in FIG. 2 emits a red light, the display cell part 62 emits a green light, and the display cell part 63 emits a blue light respectively. Thus, three display cell parts 61, 62, 63 form one pixel. In the same manner, each of other groups of three display cell parts forms one pixel. Light emission from each display cell part outgoes in the direction of the arrow A in FIG. 2. Thus an outer surface 41 of the second glass 4 serves as a display surface (hereinafter referred to as display surface 21) of the display panel body 2, and this display surface 21 is covered with the protective film 7.

In manufacturing process of the display panel body 2, the first glass 3 and the second glass 4 are sealed in almost airtight state with the seal glass 5 leaving a slight layer-like air gap (not shown). Then, the spaces in every display cell part are evacuated or made vacuum utilizing the mentioned air gap. Subsequently, to replace the vacuum with a gas for gas discharge, the spaces of every display sell are charged with the gas for gas discharge. Thereafter, the remaining part is sealed with the seal glass 5.

The protective film 7 is comprised of portions 71, 72 and 73 respectively covering the display surface 21, side face 22 and a part of the back face 23 of the display panel body 2, as shown in FIGS. 1, 2 and the development in FIG. 3. In FIG. 3, a dotted line 74 is a boundary line between the portion 71 and the portion 72. An area surrounded by the dotted line 74 almost corresponds to an area of the display surface 21 of the display panel body 2. The portion 72 between the dotted line 74 and another dotted line 75 almost corresponds to the thickness of the display panel body 2 and covers the side face 22 of the display panel body 2. The portion 73 covers a part of the back face 23 of the display panel body 2. As the protective film 7 is provided with square notches 76 at the four corners, it is possible to cover the mentioned portions of the display panel body 2 by adhesion using an adhesive without partially folding of the protective film 7. In addition, reference numeral 711 in FIG. 3 is a joint region described later.

In this manner, the end portions of the display panel body 2 are covered, without exposed portion, by extending the protective film 7 from the side face of the display panel body 2 to the back face and adhering the protective film thereto. Therefore, it is possible to disperse any external force that may be applied to the mentioned end portions. As a result, the end portion of the display panel body 2 is prevented from fracture and chipping.

The protective film 7 also performs a function as a color filter because of coloring that allows to transmit color of light emitted from each display cell part conforming to the arrangement of the display cell parts 61, 62, 63, etc. of the display panel body 2. In FIGS. 2 and 3, the regions designated by R, G and B are respectively colored with red, green and blue, and, for example, the display cell parts 61, 62 and 63 are respectively located beneath the regions. As the display cell parts 61, 62 and 63 form one pixel, the three regions of red, green and blue on the respective display cell parts 61 to 63 serve as a filter for one pixel. A joint region 711 partitions the pixel filters on the protective film 7. Looking at the display cell part 61 and the R-colored region thereon, for example, this R-colored region can cut off components other than red color component contained in the light incoming from outside into the display panel 1 as well as in the light radiated to outside by reflecting the light from outside in the display panel 1. On the other hand, the red color component emitted from the display cell part 61 is radiated to the outside without being cut off in the R-colored region. As a result, in the display cell part 61 and the R-colored region, intensity of the red color component increases, because the red color component contained in the light from outside is added to the red color component from the display cell part 61. The situation is quite the same in the display cell part 62 and G-colored region as well as in the display cell part 63 and B-colored region. Thus, color contrast is improved.

It is also preferable to give the color filter function to each colored region of R, G and B by coloring a single color instead of plural colors of red, green and blue. For example, a gray color of may be employed as such single a single color. When using the gray color instead of the red color in the mentioned R-colored region, it becomes certainly difficult for the red color component in the light to go out from the internal part as compared with the red filter. But the same function as that of the red filter is exhibited in the aspect of cutting off the light from outside, thereby contributing to the improvement in contrast. Furthermore, as only one color is required instead of the mentioned three colors, not only the manufacturing cost of the protective film 7 itself is reduced, but also manufacturing process of the display panel 1 is simplified. Cost reduction in the display panel 1 is expected from the viewpoint of such simplification of the manufacturing process of the display panel. In this manner, in case that the color filter function is added to the protective film 7, it is preferred to select either three color filters or single color filter considering the intensity of light emission and the cost required for the display panel 1.

In the invention, material of the protective film 7 is not particularly limited as far as it is capable of being adhered to the outer surface of the display panel body 2 with, for example, an adhesive and is of light-transmission. But in addition to such requirements, it is desired that the material has a good characteristic of being colored to serve also as a color filter and is resistant to ambient temperature and heat generated by the display cells 6 during operation of the display panel body 2. In this sense, acrylic resin is more preferable, for example. Furthermore, it is preferred that the protective film 7 is about 50 to 100 micrometer in thickness so that it may be folded without requiring any large rounded portion at the side face of the display panel body 2 and is superior in resistance to fracture.

As shown in FIG. 4, the protective film 7 can be prepared by continuous printing on an elongated tape T forming the protective film 7, cutting it into separate pieces and adhering them onto the outer surface of the display panel body 2 (not shown in FIG. 4). Thus, it is possible to meet the protective film 7 with continuous production of the display panel 1.

FIG. 5 (a) is a perspective view of a display unit assembled with the display panels according to Embodiment 1, and FIG. 5 (b) is an exploded perspective view of a display system using the display unit. Referring to FIG. 5 (a), the display unit 11 is comprised of: a quadratic display panel 12 formed by arranging four display panels 1 into in 2 by 2 arrangement; a terminal conversion board 13 disposed beneath the quadratic display panel 12; and a separate electrode drive circuit board 14 disposed beneath the terminal conversion board 13. On the other hand, referring to FIG. 5 (b), a display system 10 is comprised of the mentioned display unit 11, and a pulse circuit/signal processing circuit board 15 disposed beneath the display unit 11. In addition, in FIG. 6, reference numeral 11 is the mentioned display unit, numeral 16 is a video interface, e numeral 17 is a signal processing bus circuit, numeral 18 is a power source, and the arrow indicated by numeral 19 is a direction of signal flow.

A test was carried out on the fracture prevention effect of the protective film 7 as to the display panel of this Embodiment 1 provided with the protective film 7. In this test, by integrating several units of quadratic display panel 12 shown in FIG. 5., a module was assembled. Then, probability of fracture occurring at the time of manufacturing each individual display panel and that at the time of assembling were totally checked. As a result, it was acknowledged that in case of the display panels according to this Embodiment 1, fracture occurred in 1 case of 49cases (the probability of fracture: 2%). On the other hand, in case of display panels according to the prior art without any protective film 7, fracture occurred in 12 cases of 60 cases (the probability of fracture: 20%). It is understood from the mentioned test that the protective film 7 is extremely advantageous for the prevention of fracture.

### Embodiment 2

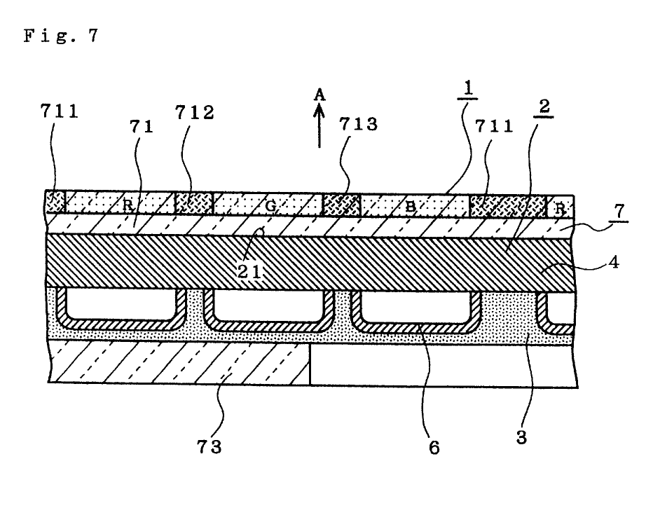

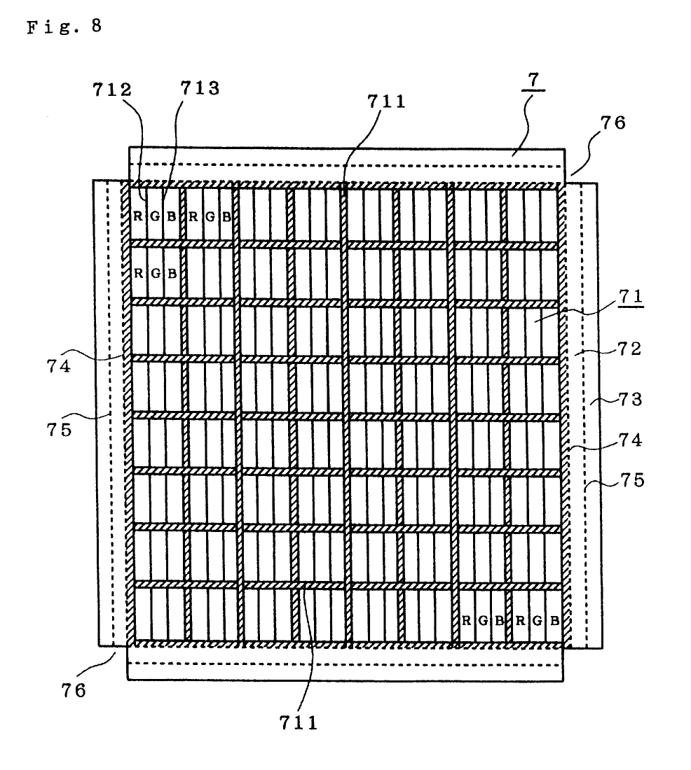

FIGS. 7 and 8 are both to explain Embodiment 2 of the display panel 1 according to the invention, and in which FIG. 7 is a partially enlarged sectional view of the display panel and FIG. 8 is a top plan view of the developed protective film. This Embodiment 2 differs from the foregoing Embodiment 1 in the aspect that a black matrix is added for light shielding. That is, in the protective film, a joint region 711, a portion 712 between the R-colored region and G-colored region in each picture element, and a portion 713 between the G-colored region and B-colored region 7 are black-colored. Addition of such black matrix for light shielding contributes to improvement in contrast by inhibiting the reflection of light incident from outside at a region having no relation to the light emission in the display panel body 2.

Note that the display panel in this Embodiment 2 can be manufactured by preparing an additional black matrix for light shielding in the same manner as shown in FIG. 4 and using the protective film 7 in the same manner as in the foregoing Embodiment 1.

### Embodiment 3

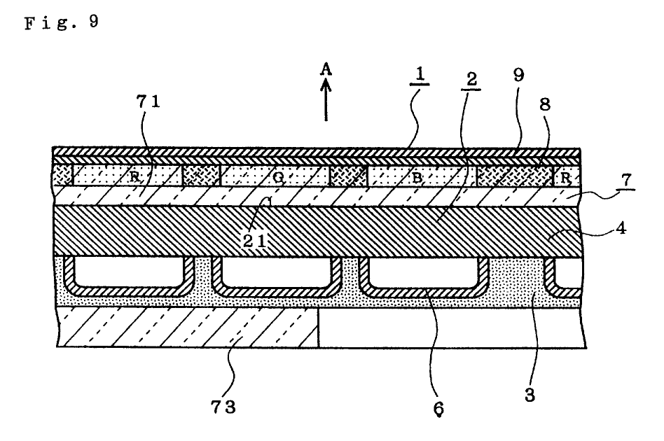

FIG. 9 is a partially enlarged sectional view of the display panel 1 showing the display panel 1 according to Embodiment 3 of the present invention. In FIG. 9, reference numeral 8 is an ultraviolet ray-cutting layer and numeral 9 is a mat-treated layer. The ultraviolet ray-cutting layer 8 is applied onto the protective film 7 and acts to prevent discoloration due to chemical degradation of the coloring material used in the formation of the mentioned R, G, B regions in the color filters. On the other hand, the mat-treated layer 9 is able to disperse the light incoming from outside and outgoing in a certain direction. In particular, the mat-treated layer 9 is able to disperse the reflection from the display surface 21 of the display panel body 2 toward a certain direction including a fluorescent light in the room, sunbeam, etc., thus acting to reduce the influence of such light.

The display panel 1 in this Embodiment 3 can be manufactured in the same manner as in the foregoing Embodiment 2, except that a three-layer composite film is employed, instead of the protective film 7 used in the foregoing Embodiment 2. The three-layer composed film is composed of a film forming the ultraviolet ray-cutting layer 8 and a film forming the mat-treated layer 9 are laminated on the protective film. In this respect, thickness of each film forming the ultraviolet ray-cutting layer 8 and the mat-treated layer 9 is not limited as far as each layer can perform the mentioned manner. In general, however, it is preferable that each film has a thickness of about 20 to 25. It is also preferable that the ultraviolet ray-cutting layer 8 is formed of a sheet of film or formed by laminating 2 to 4 sheets thereof. It is also preferable that the ultraviolet ray-cutting layer 8 and the mat-treated layer 9 are used separately from each other without being used jointly.

Each colored region indicated by R, G or B in FIGS. 2, 7, 9 and 10 and the light shielding black matrix shown in FIGS. 7, 9 and 10 are formed by applying or printing a predetermined coloring material onto a predetermined portion on the surface of the portion 71 of the protective film 7. It is preferable that the mentioned each colored region and the light-shielding black matrix is formed by applying the coloring material to the back face of the portion 71, and the intermediate part on both sides of the portion 71. It is also preferable to apply the coloring material to all of the both sides and the intermediate part of the portion 71 of the protective film 7.

### Embodiment 4

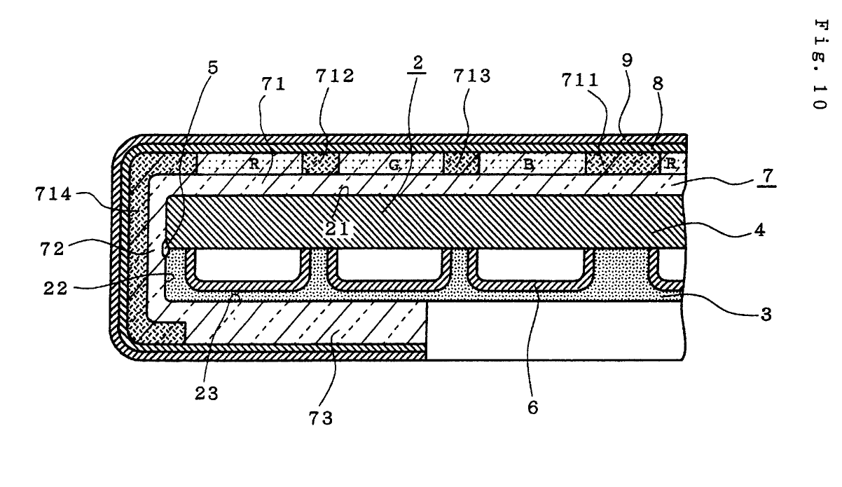

FIG. 10 is a partially enlarged sectional view of the display panel 1 for illustrating the display panel 1 according to Embodiment 4 of the invention. In FIG. 10, reference numeral 714 is a colored portion. In this colored portion 714, a coloring material is applied onto a surface of the portion covering the side face 22 of the display panel body 2. Note that the colored portion 714 extends partially to a surface of the portion 71 of the protective film 7 and partially to a surface of the portion 73 of the protective film 7. By the formation of this colored portion 714, it becomes possible to prevent the portion 72 of the protective film 7 from incidence of light from outside, leakage or reflection thereof. Therefore, it is prevented that the light emitted from the display cell located at the most outer side of the mentioned display panel 1 reflects on the end face of the glass, and that the external light comes in the end portion of the display panel 1. As a result, in the matrix type display system formed with a plurality of the display panel 1 according to this Embodiment 4, the problem that the portion between one display panel and another looks white is now solved, and uniformity in brightness is improved.

The colored portion 714 extends partially to a surface of the portion 71 of the protective film 7 and to a surface of the portion 73 of the protective film 7 in FIG. 10. It is preferable that the colored portion 714 is formed only on the portion 72 of the protective film 7. As for the colored portion 714, any color capable of reducing or preventing incident and/or reflected light including black, gray or others may be employed. However, when employing black as used in the preparation of the black matrix, the colored portion 714 maybe formed employing the same color material in the same process as the formation of the black matrix. This reduces number of the manufacturing steps, eventually resulting in cost reduction. It is also preferable that the color of the colored portion 714 is gray or the like in consideration of the transmittance of light for adjustment of degree of leakage or reflection of light. Coloring not all over the colored portion 714 but in stripes can make such an adjustment.

### Embodiment 5

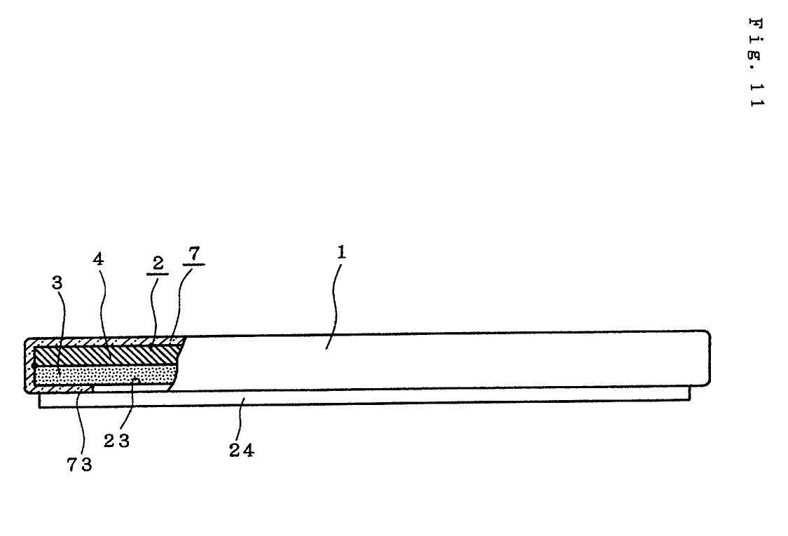

FIG. 11 is a partially cross-sectional side view of the display panel 1 according to Embodiment 5 of the invention.

In FIG. 11, reference numeral 24 is a pressing member for pressing the portion 73 of the protective film 7 onto the back face 23 of the display panel body 2. As the pressing member, for example, it is preferable to employ a housing or a box-like member accommodating therein the terminal conversion board 13 or the separate electrode drive circuit board 14 {refer to FIG. 5 (a)} for driving the display panel body 2.

Adhesive strength of the portion 73 to the back face 23 of the display panel body 2 is, in general, not so strong that the adhered portion, accordingly the protective film 7, may separate from the display panel body 2. To cope with this, as shown in FIG. 11, the portion 73 is pressed onto the back surface of the display panel 1 so as to be sandwiched between the display panel 1 and the press member 24. More preferably, the display panel 1 and the pressing member 24 are pasted together with an heat-and-electric conductive tape, etc. As a result, it becomes possible to prevent the separation of the protective film 7 without fail.

What is claimed is:

1. A display panel comprising:
a display panel body including a first glass and a second glass, said first glass having a plurality of display cells provided with a gas discharging space on a surface thereof, and said second glass being disposed on said first glass to be opposite to said display cells; and
a protective film covering not only a display surface and sides of said display panel body but also at least a part of the back side thereof.

2. The display panel according to claim 1, wherein the protective film is adhered to the display panel body.

3. The display panel according to claim 1, wherein the protective film is provided with a color portion serving as a color filter at a portion covering the display surface of the display panel body.

4. The display panel according to claim 1, wherein the protective film is provided with a black matrix for light shielding at the portion covering the display surface of the display panel body.

5. The display panel according to claim 1, wherein the protective film is colored at a portion covering the sides of the display panel body.

6. The display panel according to claim 1, wherein the protective film is provided with an ultraviolet ray-cutting layer and/or a mat-treated layer thereon.

7. The display panel according to claim 1, wherein the display panel is provided with a pressing member for pressing a portion of the protective film covering the back surface of the display panel body onto said back side.

8. The display panel according to claim 7, wherein the pressing member is a box-like member accommodating therein a driving member that drives the display panel body.

9. The display panel according to claim 1, wherein the display panel body is in the form of a flat plate.
